(19) United States
(12) Patent Application Publication
(10) Pub. No.: US 2020/0192891 A1
(43) Pub. Date: Jun. 18, 2020

(54) CORE DATA SERVICE VIEW TEMPLATE

(71) Applicant: SAP SE, Walldorf (DE)

(72) Inventor: Jan Hrastnik, Sandhausen (DE)

(21) Appl. No.: 16/219,138

(22) Filed: Dec. 13, 2018

(51) Int. Cl. G06F 16/23; G06F 16/2453; G06F 16/21; G06F 16/242; G06F 16/2455

(52) U.S. Cl. CPC G06F 16/2393; G06F 16/24549; G06F 16/212; G06F 16/24565; G06F 16/24539; G06F 16/2445; G06F 16/24535

(57) ABSTRACT

Data characterizing a design time model and an identification of a use case for the design time model is received. The design time model includes logic characterizing a database view. A predefined set of rules associated with the use case is received. A runtime model of the database view is generated using the design time model and according to the predefined set of rules. The generating includes building the runtime model from the design time model and automatically removing logic from the design time model, the removed logic being unused and removed according to the predefined set of rules associated with the use case. The runtime model is provided. Related apparatus, systems, techniques and articles are also described.

### TECHNICAL FIELD

The subject matter described herein relates to database management systems.

### BACKGROUND

Core Data Services (CDS) can include an infrastructure that can be used by database developers to create the underlying (e.g., persistent) data model, which application services expose to user interface clients. The database developer can define the data-persistence and transformations thereof and analytic models that are used to expose data in response to client requests. With CDS, a database model can be defined that includes objects such as tables, views, and structured types. The database objects can specify what data to make accessible for consumption by applications and how.

CDS views can be used to push down logic to the database system for execution. For example, CDS view models can be transferred to the database without any optimization as plain create view structured query language (SQL) statements. At runtime, the database optimizer can calculate an execution plan based on the supplied create view SQL statements and statements of the consumer (which may include additional filter conditions, and the like). However due to a lack of contextual information and semantical knowledge, the database optimizer typically may not determine the globally optimal execution plan. In addition, the preparation time can become quite high (up to minutes). As a result the runtime performance can be comparably low while at the same time the memory and CPU consumption can be high.

### SUMMARY

In an aspect, data characterizing a design time model and an identification of a use case for the design time model is received. The design time model includes logic characterizing a database view. A predefined set of rules associated with the use case is received. A runtime model of the database view is generated using the design time model and according to the predefined set of rules. The generating includes building the runtime model from the design time model and automatically removing logic from the design time model, the removed logic being unused and removed according to the predefined set of rules associated with the use case. The runtime model is provided.

One or more of the following features can be included in any feasible combination. The generating can include evaluating design time model metadata using the predefined set of rules. The design time model can include logic including a first join operation. The generating can include identifying that the first join of the design time model is unused for the identified use case and removing the first join from the runtime model. The generating can include adding, to the runtime model and according to the predefined set of rules, an annotation, an element, a field, and/or an access protection. The runtime model can include structured query language expressions. The set of rules can include annotation of a core data services entity. The use case can include an intended application configured to consume database query results utilizing the runtime model of the database view. The receiving can be performed using a user interface application. Differences between the design time model and the run time model can be detected. The detected differences can be provided via a graphical user interface to a user interface associated with a developer. An update to the design time model can be received. The design time model can be updated. The run time model can be synchronized with the updated design time model. At least one of the receiving, the generating, and the providing are performed by at least one data processor forming part of at least one computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating an example high-level runtime architecture stack;

FIG. 2A-2C illustrate some example scenarios illustrating CDS activation problems;

FIG. 3 is a system block diagram illustrating an example CDSVT infrastructure;

FIGS. 4-7 illustrate example scenarios in which joins can be eliminated; and

FIG. 8 is a process flow diagram illustrating an example process of generating a runtime model.

Like reference symbols in the various drawings indicate like elements.

### DETAILED DESCRIPTION

Some implementations of the current subject matter include template CDS models that enable decoupling of design time models from their effective static runtime model. Some implementations can utilize a CDS view templating (CDSVT) infrastructure. Using some implementations, the developer can maintain semantically rich, reusable template models, and then invoke a tool-supported conversion of these models into suitable runtime models that can be pre-optimized for serving a dedicated use case. During the tool-supported conversion, all CDS metadata of the template model can be evaluated automatically by the CDSVT in order to derive an optimized runtime model at an SQL level (e.g., by elimination of unnecessary joins and elimination of intermediate projection views) for a given use case. A developer can specify the design time model template, an intended use case, and the conversion can automatically convert the design time model template into a runtime model specific to the use case.

In some implementations, during the conversion process, a predefined rule set associated with the selected use case can be utilized to remove unneeded logic from the design time model template. Further, the CDSVT can take into account specifics of implementation frameworks (such as Open SQL, Service Adaptation Definition Language (SADL), Enterprise Search and Analytics). Additionally, the resulting runtime models can be augmented in accordance with their envisioned usage by at least adapting and adding the required CDS annotations, elements, access protections by data control languages (DCLs), and the like. The developer may control the automatically applied conversion logic in a flexible manner and can fine-tune the resulting generated runtime models manually. In some implementations, a single template model (which can include a design time model, and/or a (generated) runtime model) can serve as the basis for deriving multiple specialized runtime models that are specialized based on the use case.

Design time and runtime models can be isolated from one another. A design time model does not need to be implemented on the SQL level, but can include a CDS model without a corresponding representation on the database system, such as an abstract template model. In some implementations, the design time model can be a locally defined model. This can allow the database system to become more flexible and fault tolerant in the course of refinements to the system, since no data dictionary (DDIC) activation is required and thus limited consistency constraints (e.g., syntactical consistency during the conversion process) can apply. The developer can be expected to define a single semantic rich reuse view as a template design time model. This model can represent the latest state of the application. For example, it can align with the latest application changes without needing to restrict changes to only compatible changes (which can be, e.g., obligatory for released runtime models that are subject to stability contracts), which otherwise might block introducing innovations into an application.

In some implementations, a dedicated synchronization and check option can allow keeping both the design time and runtime models in sync. For example, changes of the design time models can be incorporated into the runtime model on demand in a consistent, controlled and conscious way (and without causing unwanted side-effects). This approach can increase developer efficiency as the developer utilizes a single template model, even if there are multiple runtime realizations generated thereof. The CDS view templating (CDSVT) infrastructure can also handle logic of the consuming frameworks and can offer corresponding automated adaptions of the generated runtime models on demand and without the developer to actively follow up on the framework changes.

Some implementations of the current subject matter include reusable CDS view models (e.g., templates) that can encapsulate functionality. In order to establish an efficient programming model, for example, to improve the maintainability of the software and offer a convenient developer experience, functionality can be capsulated in reusable CDS views. Designed as semantic rich data models, the reused CDS views can be applicable to a number of use cases and may not be optimized for a specific individual use case. In some implementations, it may not be possible for a developer to tailor such a reuse view for dedicated use cases without hampering others as a result of conflicting requirements. An additional challenge can result since consuming frameworks like Service Adaptation Definition Language (SADL) and Analytical Engine (AE) can interpret the captured metadata of the CDS view models differently (e.g., foreign key associations can be handled differently).

The reuse of views and their logic as building blocks of the applications can result in complex interdependent hierarchies and networks of views. In some database systems, there can be view hierarchies defined that include more than 20 levels of nested views. A single view may also associate a three digit number of related other views. This high number of dependencies can causes severe DDIC activation issues (e.g., model inconsistencies and long activation times, which can jeopardize the entire development process and put lifecycle events like an upgrade of customer systems at risk). Besides refactoring (e.g., renaming of a field) of a fundamental reuse view (e.g., the CDS view I_CompanyCode, which can be used as a data source by more than 2000 CDS views) within the view stack, immediate adaptions of consuming views can be required in order to meet DDIC consistency requirements. Additionally, once activated, the changes of fundamental views immediately become effective for all dependent views and may result in unwanted and unforeseen side effects, which furthermore can be difficult to control and detect for their consumers. Some implementations of the current subject matter can overcome the above-noted drawbacks.

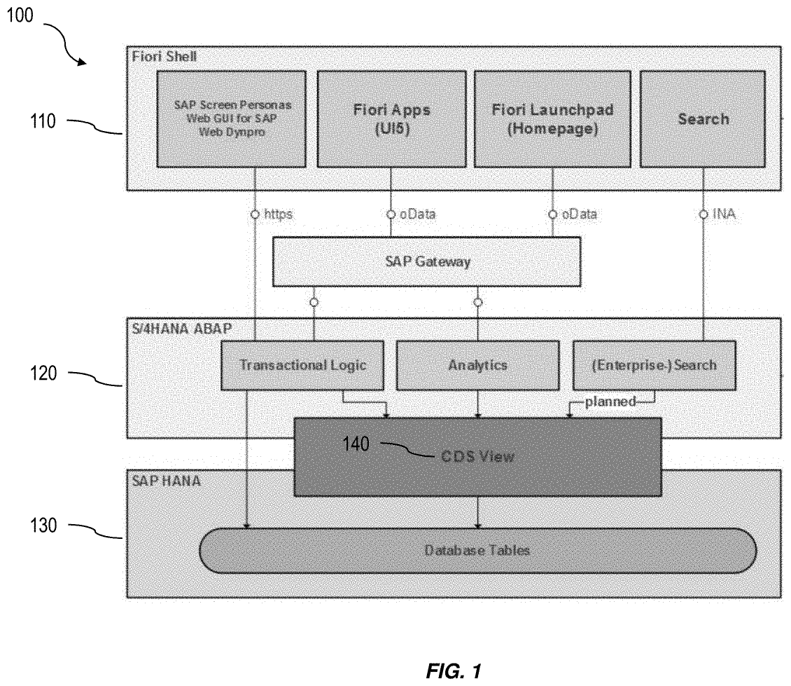

FIG. 1 is a system block diagram illustrating an example high-level runtime architecture stack 100 for a database system such as HANA (available from SAP SE of Walldorf, Germany). The runtime architecture stack 100 includes a client layer 110 (e.g., UI layer), an application server 120 (e.g., ABAP), and a database layer 130. The CDS view layer 140 can reside in both the language layer 120 and the database layer 130. The CDS view layer 140 including associated models can interconnect the logic implemented in the application server 120 with the database layer 130. The CDS model includes representations on the application server 120 as well as in the database layer 130. In some implementations, CDS support intention based definitions of data models and relationships thereof without confronting developers with the full technical complexity of SQL.

CDS view models can become complex due to the fact that logic can be pushed down to the database. This complexity can increase since views can be defined as semantic rich data models allowing support of a variety of use cases. In addition, the view logic can be reused within the view stack for supporting an efficient development experience as well as for supportability and maintainability. Furthermore, technical constraints of CDS views (e.g. missing support for sub-selects, restrictions on the usage of cast operations in conjunction with functions, and the like) can enforce an introduction of workarounds like the introduction of additional intermediate views, which can contribute to the overall complexity of the CDS models.

In some existing approaches, CDS view models can be handed over to the database as plain SQL views in the same way as they are modelled (e.g., without any pre-optimizations). This can imply that due to the direct mapping onto database artifacts, the CDS view interdependencies are transferred onto the database system as well. The database can be expected to optimize the view models itself for efficient runtime execution based on the plain SQL statements that it receives.

An example semantic rich CDS view model is described in the following table 1.

TABLE 1
@AbapCatalog.sqlViewName: ‘CSDSALESORDERIL’
@AbapCatalog.compiler.compareFilter: true
@AccessControl.authorizationCheck: #CHECK
@Analytics.dataCategory: #DIMENSION
@ObjectModel.representativeKey:‘SalesOrderItem’
define view C_SalesOrderItemList as select from I_SalesOrderItemList
{

@ObjectModel.foreignKey.association: ‘_SalesOrder’

```
  key I_SalesOrderItemList.SalesOrder,
  key I_SalesOrderItemList.SalesOrderItem,
```

@ObjectModel.foreignKey.association: ‘_SalesOrderType’
SalesOrderType,
_SalesOrderType,
_SalesOrder

}

An example of the automatically derived create statement of the database view is shown in the following table 2.

TABLE 2

CREATE VIEW “CSDSALESORDERIL” AS SELECT

“ISDSALESORDERIL”.“MANDT” AS “MANDT”,
“ISDSALESORDERIL”.“SALESORDER”,
“ISDSALESORDERIL”.“SALESORDERITEM”,
“ISDSALESORDERIL”.“SALESORDERTYPE”

FROM “ISDSALESORDERIL” “ISDSALESORDERIL”

Interdependencies can result in a complex network/hierarchy of joined views, which can be considered for deriving the optimized runtime model. As an example, in the HANA system there are view hierarchies with more than 20 levels and consume several hundred of views.

In general, the calculation of the most efficient execution plan depends on the fourth power of the number of involved joins. This implies that for view stacks, which embed more than 10 joined views, the globally most efficient execution plan cannot be practically calculated. Instead a local optimization can be achieved. The calculation of this execution plan can consider not only the view modeling, but also the amount of data that is stored in the system and the filter criteria of a selection. Even though a derived execution plan only may represent a local optimum, the preparation of this plan can be time consuming and can require significant memory. Since the calculation can be sensitive for the persisted data and actual selection request, the execution time of the selection cannot always be predicted, which can result in unexpected issues for the users.

Despite the fact that the runtime optimization becomes difficult with an increase of the complexity of CDS view models, there are technical constraints imposed by the databases that may prevent a complex view model to be successfully activated as well. It may only be possible to activate complex CDS view models on powerful databases.

Due to the high number of involved interdependent reuse views the activation process can become error-prone and time consuming, which can impair the entire development and maintenance processes.

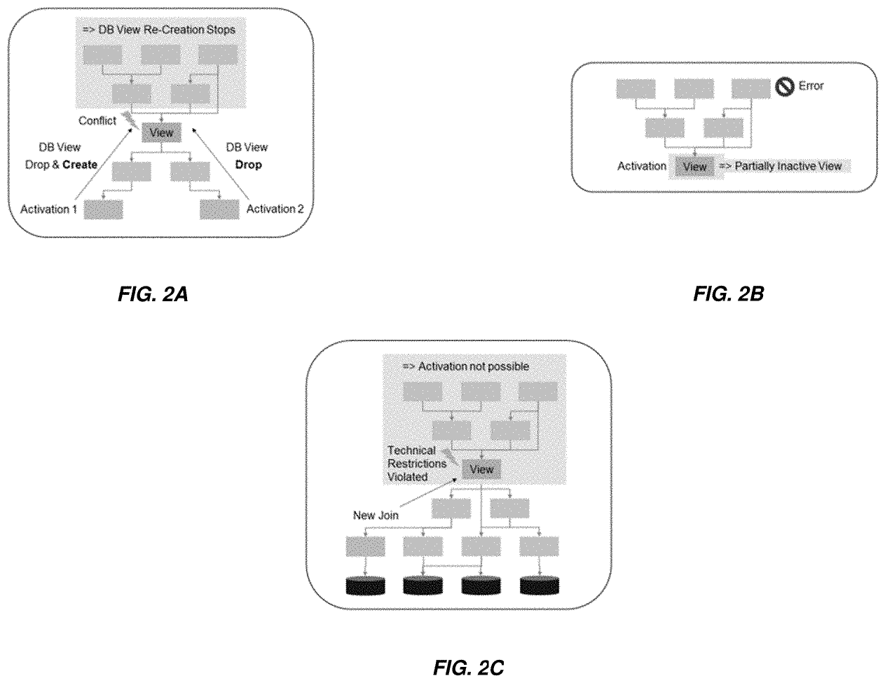

FIG. 2A-2C illustrate some example scenarios illustrating CDS activation issues. Each block in FIGS. 2A-2C represents a view and arrows indicate relations (e.g., dependencies) of type “select from”. Upper views select from lower view. In FIG. 2A, activations 1 and 2 are concurrent, and so the drop-in/create operations of an SQL view hierarchy can result in inconsistency by concurrent activations. In FIG. 2B, release of transports containing partially active views may not be possible because of inconsistent dependent views. The inconsistency of dependent view may not be caused by changes of activated view. In addition, correction of dependent views may not address the inconsistency. In FIG. 2C, a development system can have a limit to the number of allowed joined data sources. As illustrated in FIG. 2C, if the limit is reached, activation may no longer be allowed. Similar to the negative impact of changes of reuse views on the activation process, automated immediate inheritance of CDS model changes, e.g., of CDS annotations over the entire CDS view stack, can result in inconsistencies, which may not be controlled without stopping an inheritance chain in general and thus without increasing maintenance efforts.

Some implementations of the current subject matter include Core Data Service View Templating (CDSVT). In some implementations, CDSVT can allow the developer to express intent when modeling a CDS view. A developer can reuse views for convenience and efficiency and in the course of design time modeling without the need to use them simultaneously as static runtime models.

The captured CDSVT model can be defined as a semantic rich design time model (without generated runtime artifacts). This design time model can be converted in a static runtime view model optimized for efficient database execution that can be passed to the database.

Within the conversion, all metadata captured in the design time template view models (including annotations and associations as well as semantic knowledge e.g. about field names) can be taken into account by the CDSVT infrastructure for optimizing the runtime view model. In this context, the CDSVT infrastructure can consider a runtime view consuming domain when optimizing the CDS model. For example, in enterprise search view model operations which are not supported or used within the search use case can be removed automatically. The generated CDSVT runtime model therefore can include those fields which are relevant for search (@Search.defaultSearchElement:true) and which at the same time do not cause runtime issues. For example, statements or fields which prevent the successful application of the CONTAINS statement can be automatically removed.

The developer may provide the CDSVT infrastructure with additional information for the conversion. This can include identifying a use case that can be covered by the generated runtime model. The developer may select one of a number of pre-defined use cases that are supported by CDSVT. When choosing one of the given use cases, the CDSVT evaluates the underlying template model and evaluates the requirements of the usage scenario and logic of the implementation frameworks.

In some implementations, all views in the stack can be exploded down to database tables and table functions level. However, the developer may flexibly control which views shall be excluded from the optimizations and shall stay and be reused also in the runtime model. In some implementations, the developer may define a replacement of views used in the design time model by runtime views (e.g., basic views of the virtual data model, views which shall serve as database result caches or which are well-tested may be retained). Using some implementations of the current subject matter, the reuse of static runtime models and thus the degree of interdependencies can be controlled in a flexible manner by the developer when running the conversion process.

In some implementations, the developer may refine the automatically derived static runtime view model by providing the CDSVT with additional information. For example, the developer may specify explicitly that the enforcement of existence checks for join partners are not required. This can allow the CDSVT to optimize the derived CDS view model by removing unnecessary joins or replacing inner with left outer joins.

In some implementations, the developer can be enabled to maintain the generated runtime view model manually and transfer the performed changes back to the design time template view. Wizards and checks of the CDSVT infrastructure can support the developer in the conversion process and in their refinement activities. In this context, the CDSVT can provide the developer proposals for improving the runtime data model, which may not result in the same functionality as specified by the design time model (e.g., apply conversion logic to already aggregated data records instead of converting individual records) and as such may not be directly derived from the template model. The developer can accept or reject these suggestions based on their knowledge about the use case.

The propagation of element annotation can be stopped in the generated runtime model. All relevant annotations can be directly copied into the generated runtime model. This can help prevent uncontrolled propagation of annotations and their changes across the view stack, which otherwise can result in inconsistencies. In addition, the required evaluation time of annotations can be reduced at runtime.

In some implementations, the CDSVT can provide checks that can inform the developer about detected differences between the CDS runtime view model and its design time template model (which could, for example, result from changes of reuse template views). The developer can then decide whether and at which point in time they want to update the optimized runtime CDS view model based on the latest changes or whether they want to ignore these changes and keep the current decoupled state of the runtime model.

In some implementations, the CDSVT design time template model may be realized by a dedicated CDS model that does not have a SQL view, but which can be realized as an abstract model. In some implementations, design time model can include regular CDS views and CDS table functions, which can leverage existing CDS infrastructure. The generated runtime CDS model can include a regular CDS view and/or table function. Information about the model origin and the applied conversion logic can be captured within the generated runtime model for example by a set of CDS annotations of the new annotation domain @ViewTemplating. This can ensure that the definition of the generated runtime view is self-contained. The following table 3 includes exemplary annotations of the annotation domain @ViewTemplating.

```
TABLE 3
@Scope: [ENTITY]
define annotation ViewTemplating: {
  @Scope: [ENTITY, ROLE]
  master: { object: {name: String(60); type: String(4) enum {#STOB;#DCLS}};
  useCase: String(60) enum {VALUE_HELP; ENTERPRISE_SEARCH;
UI_SERVICE; REMOTE_API; DECOUPLED_MODEL;
```

SQL_DATA_SOURCE; ANALYTICAL_INFO_SOURCE;

ANALYTICAL_QUERY; FORM_TEMPLATE;};
option: array of { name : String(60) enum
{DENORMALIZE_FOREIGN_KEY_TEXT;

```
  ADD_FIELD_FOR_DCL;
  IGNORE_JOIN_PARTNER_EXISTENCE;
  USE_CONVERSION_AFTER_AGGREGATION;
  IGNORE_VALUE_CHANGE_BY_FUNCTION;
  ADD_VALUE_HELP_FOR_FOREIGN_KEY;
  ADD_OR_VALUE_HELP_ACTIVITY_TO_DCL;
  };
```

excluding : Boolean default true;};

dependency: array of { object: {name: String(60); type: String(4) enum {#STOB;}};

replacedObject: {name: String(60); type: String(4) enum {STOB;

TABL; VIEW}} };
synchronization: { element: array of {name: String(255); excluding: Boolean default
true;};

```
function: array of {name: String(255); excluding: Boolean default true;};
annotation: array of {
  @Scope: [ENTITY, ELEMENT, PARAMETER]
  name: String(255);
  scope: array of String(60) enum {ENTITY; ELEMENT;
```

PARAMETER};

```
  @Scope: [ENTITY, ELEMENT, PARAMETER]
  excluding: Boolean default true;};
check: { priority: String(60) enum {LOW; MEDIUM; HIGH;
```

VERY_HIGH;}; }; };
}

In some implementations, Data Control Language (DCL) models can utilize the CDSVT infrastructure.

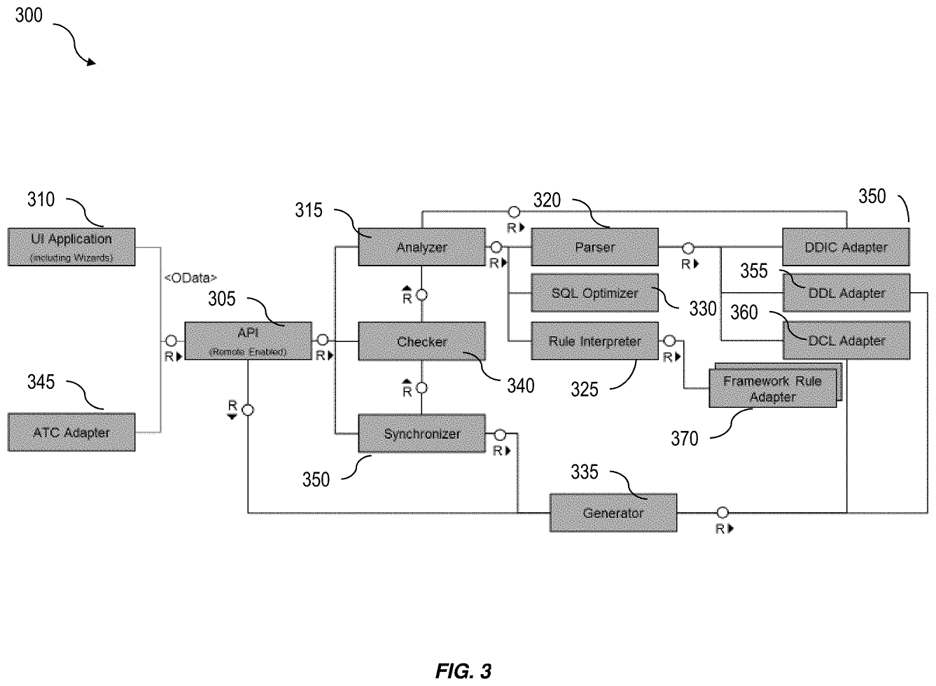

FIG. 3 is a system block diagram illustrating an example CDSVT infrastructure 300. The CDSVT infrastructure 300 can include an application programming interface (API) 305, a user interface (UI) application 310, an analyzer 315, a CDS parser 320, a rule interpreter 325, an SQL optimizer 330, a generator 335, a checker 340, an ABAP Test Cockpit (ATC) adapter 345, a synchronizer 350, DDIC adapter 355, DDL adapter 360, DCL adapter 365, and framework rule adapter 370.

The API 305 can enable access to functionality of the CDSVT 300. In some implementations, the API 305 can be invoked locally in an ABAP stack and/or called remotely. The UI application 310 can include administrative and analysis UIs as well as of wizards, which can support the user to leverage and apply the lifecycle processes of the CDSVT infrastructure 300. The analyzer 315 can analyze CDS models and provide an optimized runtime model as well as suggestions for further optimization options. The CDS parser 320 can deserialize the CDS (and/or DCL) models and provide information about data sources, fields, data elements and the like via corresponding adapter classes (DDIC adapter 355, DDL adapter 360, and DCL adapter 365). It can also fetch the effective annotations from the CDS annotation API.

The rule interpreter 325 can evaluate the parsed CDS model and given use case (as well as any additional specific settings/information provided by the user) in order to derive requirements and the signature/interface of the optimized runtime model. Rules of the supported individual engines and frameworks can be included into this evaluation via dedicated adapters, such as the framework rule adapter 370.

The SQL optimizer 330 can provide a SQL view hierarchy definition which can be optimized for database processing. The SQL optimizer 330 can receive the results of the parser 320 and of the rule interpreter 325 as input along with further information from the developer for defining the view stack.

The generator 335 can create and update the runtime models. In some implementations, the generator 335 can also create and update the design time models.

The checker 340 can calculate the delta between the design time template model and its derived runtime models by analyzing the CDS and DCL models. It can provide both the delta of the metadata as well as related messages for the end user.

The ATC adapter 345 can integrate the checker 340 functionality into ATC for a continuous automated check of the runtime models.

The synchronizer 350 can invoke check functionality to determine deltas and use them to update the models via the generator functionality.

In some implementations, the adapter classes can decouple the CDSVT components from existing metadata repositories and functionalities. They can also support logical extensions/enhancements thereof via implemented exits.

The following table 4 includes an example design time model template definition.

TABLE 4
@AbapCatalog.sqlViewName: ‘ISOTEMPLATE’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@Analytics.dataCategory: #DIMENSION
@ObjectModel: { compositionRoot: true,

representativeKey: ‘SalesOrder’ }

```
@VDM.viewType: #COMPOSITE
@Search.searchable: true
define template view I_SalesOrderTemplate
  as select from I_SalesDocumentTemplate
  association [0..1] to I_SalesOrderTypeTemplate as _SalesOrderType
```

on $projection.SalesOrderType = _SalesOrderType.SalesOrderType

```
association [0..*] to I_SalesOrderItemTemplate as _Item
  on $projection.SalesOrder = _Item.SalesOrder
  association [0..1] to I_CustomerTemplate as _SoldToParty
```

on $projection.SoldToParty = _SoldToParty.Customer

{
key cast( SalesDocument as vdm_sales_order preserving type ) as SalesOrder,

```
  @ObjectModel.foreignKey.association: ‘_SalesOrderType’
  SalesDocumentType as SalesOrderType,
  @Search.defaultSearchElement: true
  @ObjectModel.foreignKey.association: ‘_SoldToParty’
  SoldToParty,
  @DefaultAggregation: #SUM
  @Semantics.amount.currencyCode: ‘TransactionCurrency’
  TotalNetAmount,
  @Semantics.currencyCode: true
  TransactionCurrency,
  @ObjectModel.association.type: [#TO_COMPOSITION_CHILD]
  _Item,
  _SalesOrderType,
  _SoldToParty
```

}

In some implementations, a design time model template may be based on other template models, on data base tables, or on runtime models. A runtime model, however, may not be based on and/or consume a template model.

In the example of DCL models, table 5 includes an example design time DCL model template definition.

TABLE 5

```
@EndUserText.label: ‘Auto assigned mapping role for
I_SalesOrderTemplate’
@MappingRole: true
define role I_SalesOrderTemplate {
  grant select on I_SalesOrderTemplate
  where ( SalesOrderType ) =
  aspect pfcg_auth ( v_vbak_aat,
```

auart,
actvt = ‘03’ );

}

The use case can include a set of predefined rules for converting the design time model into the runtime model. In some implementations, this set of rules can be expressed explicitly by using the detailed annotations of the annotation domain @ViewTemplating. For example, the following table 6 includes annotations expressing example rules.

```
TABLE 6
@ViewTemplating.synchronization:{
  element: [ {name: ‘KeyField1’}, ..., {name: ‘KeyFieldN’} ],
  annotation:[ {name: ‘ObjectModel.dataCategory’, excluding:true},
```

```
  {name: ‘Metadata.ignorePropagatedAnnotations’, excluding:true},
  {name: ‘ObjectModel.foreignKey’, excluding:true},
  {name: ‘ObjectModel.text’, excluding:true},
  {name: ‘Consumption.valueHelpDefinition’, excluding:true},
  {name: ‘AbapCatalog.sqlViewName’, excluding:true} ...],
```

option: [ {name: #DENORMALIZE_FOREIGN_KEY_TEXT},

{name: #ADD_VALUE_HELP_FOR_FOREIGN_KEY},
{name: #ADD_FIELD_FOR_DCL},
{name: #ADD_OR_VALUE_HELP_ACTIVITY_TO_DCL} ]

}

In some implementations, the predefined rules for a given use case may change in the future (e.g., because of evolving framework support), the explicitly defined detailed annotations fix the current state of the use case rules. Accordingly, the runtime models may be different if the generation is applied in future.

After the use case is specified, the CDSVT analyzer can evaluate the design time template model. The CDSVT can parse the entire view hierarchy stack down to the database tables. For relevant elements in the projection list of the template view the path down to the database field can be evaluated. The evaluation can stop at complex logic, which may not be broken down to the underlying database fields (e.g., because a wrapping CDS table function cannot be parsed).

In some implementations, the scope of relevant elements can be determined by the use case. For example, if an enterprise search model is generated only the fields which are annotated with @Search.defaultSearchElement:true can be considered. Additionally, fields that define the semantic key of the searched object and fields that are relevant for the definition of a DCL can also be regarded as relevant. Other elements can be ignored for the search use case.

In some implementations, instead of using the database tables as data sources for the fields (e.g., default behavior), the developer may decide to retain a given data source and/or to replace it. For example, the developer may decide to reuse the runtime model I_SalesDocument as the data source for the generated runtime model of I_SalesOrderTemplate. In this context, I_SalesDocument can replace the existing template data source I_SalesDocumentTemplate. As an example, this can be captured in the generated runtime model by the following example annotation: @ViewTemplating.dependency:[{object: {type:#STOB,name:‘I_SalesDocument’}, replacedObject: {type:#STOB, name:‘I_SalesDocumentTemplate’}].

In some implementations, the CDSVT wizard can prompt the potential data sources and replacement options to the developer enabling selection by the developer. Replacing views can be pre-analyzed such that they cover the required source elements. For example, they can be used for replacing the corresponding template model within the runtime model.

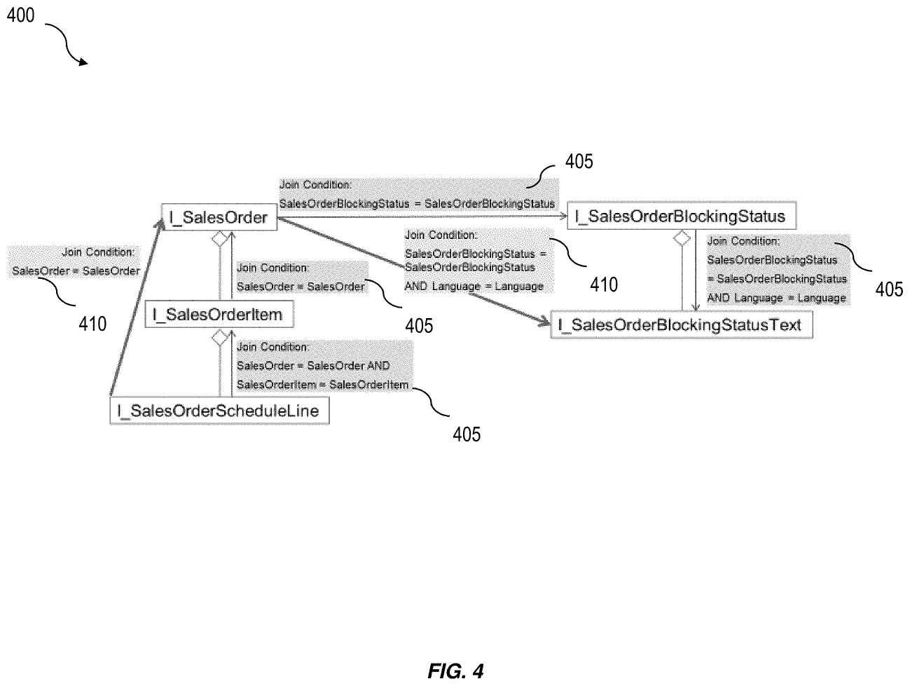

After defining the use case and the desired data sources for the runtime model, the CDSVT SQL optimizer can be invoked. The default SQL optimization can lower the static view complexity, which can be primarily driven by the number of joins. The optimizer can attempt to eliminate superfluous joins, which can be introduced, for example, by self-joins, by duplicate joins over the view stack, by joined fields of base views which are not part of the projection list, unnecessarily long association/join paths, and the like. In addition, superfluous intermediate base views can be eliminated. The superfluous intermediate base views may be views that may not be required for implementing the current view logic or which can be replaced by sub-selects in future. FIGS. 4-7 illustrate example scenarios in which joins can be eliminated.

FIG. 4 illustrates an example scenario 400 in which joins can be automatically reduced by evaluation of metadata (e.g., compositional relationships). The number of joins can be reduced from 4 to 2 without functional modification. Such a reduction may not be achievable if the template model is executed in the database. In FIG. 4, sections 405 reflect join logic of the design time model. For example, the view I_SalesOrderItem is related to the view I_SalesOrder by the condition SalesOrder=SalesOrder. Similarly, the view I_SalesOrderScheduleLine is related to the view I_SalesOrderItem via a join condition SalesOrder=SalesOrder and SalesOrderItem=SalesOrderItem. Since a schedule line can only exist if it is assigned to the sales order item, which in turn can only exist if the item is assigned to a sales order header, these two joins can be condensed to a single join from the view I_SalesOrderScheduleLine to the view I_SalesOrder with the condition SalesOrder=SalesOrder. This join 410 can become part of the generated runtime model.

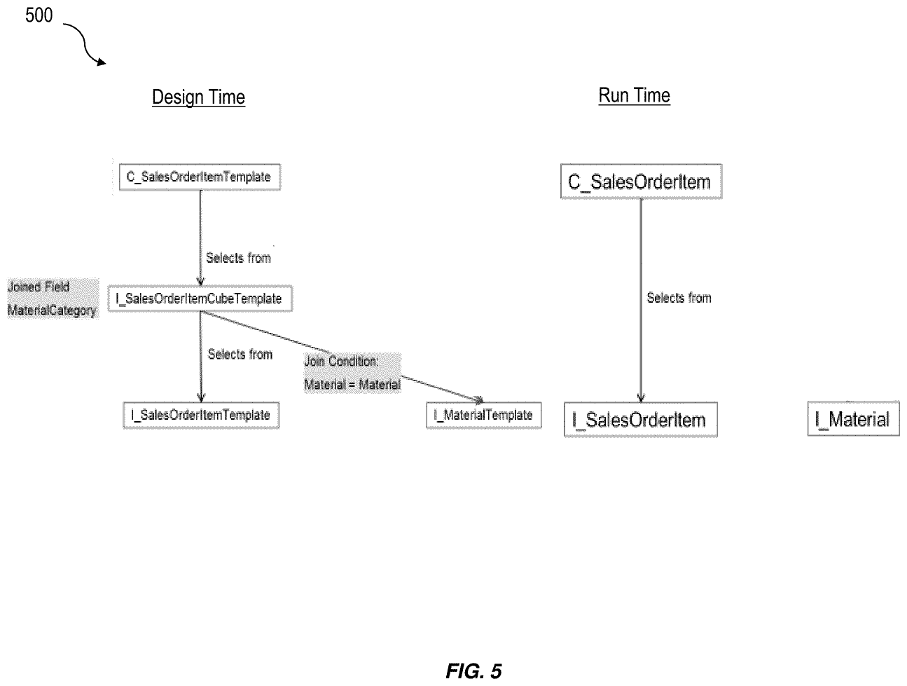

FIG. 5 illustrates another example scenario 500 in which joins can be reduced by removal of superfluous intermediate view and joins. As illustrated, if the base template view I_SalesOrderItemCubeTemplate contains a joined field MaterialCategory which is not part of the projection list of the current template view C_SalesOrderItemTemplate, the corresponding join can be removed from the generated runtime model C_SalesOrderItem. It can fetch all data directly from the runtime view I_SalesOrderItem.

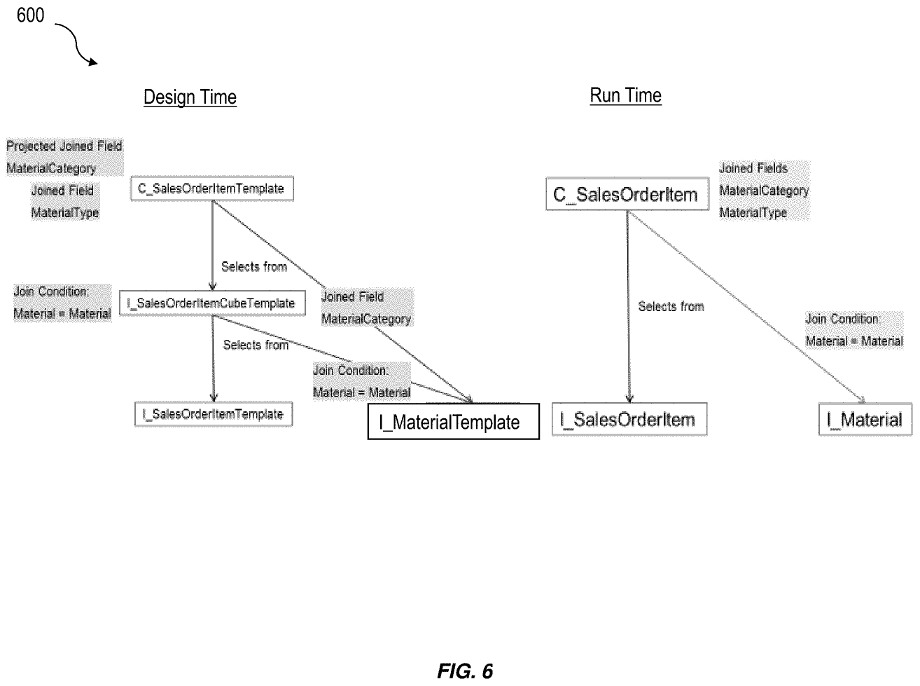

FIG. 6 illustrates another example scenario 600 in which joins can be reduced by merging joins maintained at different levels of the view stack. The number of joins can be reduced from 2 to 1 without functional modification. In the design time model the view I_SalesOrderItemCubeTemplate uses a join to the view I_MaterialTemplate for including its field MaterialCategory. The template view C_SalesOrderItemTemplate projects this field. Additionally, it uses another join for integrating the field MaterialType. In the generated runtime model C_SalesOrderItem both these fields are fetched by using a single join with the runtime view I_Material.

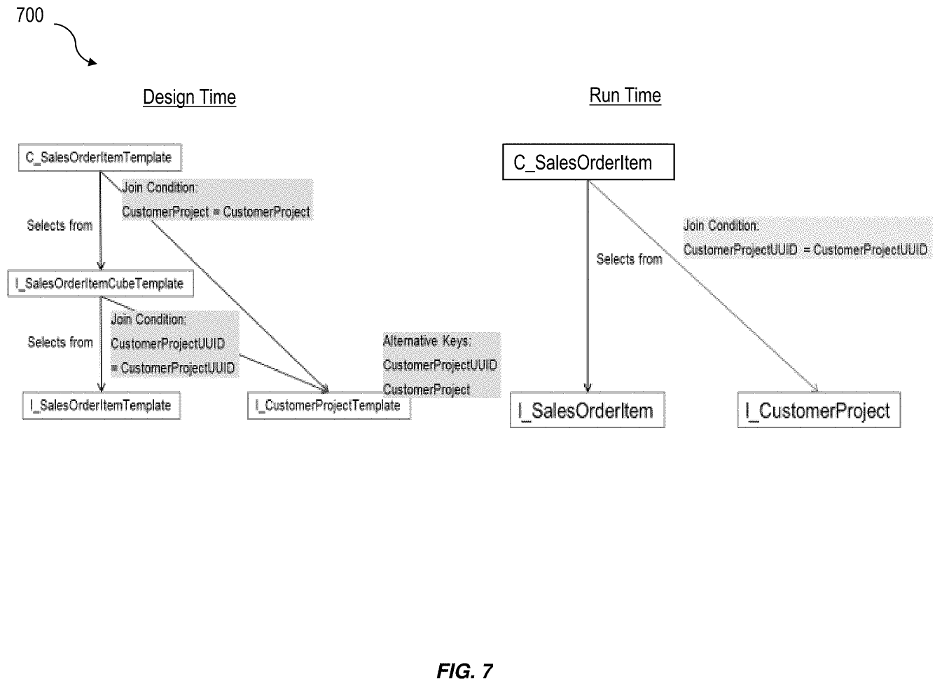

FIG. 7 illustrates another example scenario 700 in which joins can be reduced through use of semantic knowledge of the CDS views. The number of joins can be reduced from 2 to 1 without functional modification. In the design time models the view I_CusotmerProjectTemplate is joined by its fields CustomerProjectUUID respectively CustomerProject. The resulting joins can be condensed in the runtime model C_SalesOrderItem knowing that both the fields are alternative key fields, which both uniquely identify a record of the view I_CustomerProject. This information can be captured, for example, with corresponding CDS annotations in the design time model I_CustomerProjectTemplate.

In some implementations, superfluous SQL operations can be eliminated. Time consuming operations can be pushed to a level where they can be applied efficiently. For example, conversions can be performed on aggregated data. In contrast, constraints such as filters and where-conditions can be pushed down to the data sources reducing the processed records.

In the instance that results change by applying an SQL-optimization, in some implementations, the optimization is not applied by default by CDSVT SQL optimizer. Instead, the developer explicitly overrules the default conversion logic. For example the developer may explicitly specify via annotations like @ViewTemplating.option: [{name:#IGNORE_JOIN_PARTNER_EXISTENCE}], that also outside of the context of compositional relationships, existence checks shall not be applied. Similarly, the developer may specify that conversions (e.g. currency conversions) can be pushed up the stack to the level of aggregated data via annotations like @ ViewTemplating.option: [{name:#USE_CONVERSION_AFTER_AGGREGATION}]. If such optimization options exists, the CDSVT analyzer can inform the developer accordingly. If the developer chooses such an optimization option, the CDSVT optimizer can re-execute its SQL analysis, which can result in new suggestions for further improvements (e.g., an iterative process).

In some implementations, once the SQL optimization is completed, the developer can define the name and type of the corresponding generated runtime model as well as a package and transport request. Captured information can be passed to the CDSVT generator, which can create the runtime CDS view and, if required, the DCLs. The DCLs can receive the same name and package assignments as the runtime CDS views.

An example use can include a “Value Help” use case. Value help views can support the user when entering IDs or code values. By default, they can follow the need to know principle and can therefore be lean to avoid exposure of sensitive information. As a result, the value help CDS view can restrict the list of exposed fields to the key fields, their texts, and required fields for defining a suitable DCL. The following table 7 includes an example generated value help runtime CDS view.

TABLE 7

@ViewTemplating: { master: { object:{ type:#STOB,
name:‘I_SalesOrderTemplate’} },

useCase: #VALUE_HELP,
synchronization: { check: { priority: #HIGH } }

}

```
@AbapCatalog.sqlViewName: ‘ISOSTDVH’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@ObjectModel.dataCategory: #VALUE_HELP
@ObjectModel.representativeKey: ‘SalesOrder’
@VDM.viewType: #COMPOSITE
@Metadata.ignorePropagatedAnnotations: true
define view I_SalesOrderStdVH
  as select from vbak
{
  key cast ( vbak.vbeln as vdm_sales_order preserving type ) as
SalesOrder,
```

| | |
|---|---|
| vbak.auart | as SalesOrderType |

} where vbak.vbtyp = ‘C’

The runtime model can select its data directly from the database table (e.g., default SQL optimization logic) and the filters which are applied within the view hierarchy can be pushed down to this level (vbak.vbtyp=‘C’).

The DCL can be defined in a such a way, that the customer is not forced to grant their users unwanted authorizations of foreign applications. This can be achieved by introducing a dedicated value help activity e.g., ACTVT=F4 that is combined by an OR operator with the original display activity e.g. ACTVT=03. Note that the use case is not captured in the runtime DCL model itself, but derived from the protected runtime CDS view I_SalesOrderStdVH. The following table 8 includes an example description of generated value help runtime DCL model.

TABLE 8

```
@ViewTemplating: { master: { object: { type:#DCLS,
name:‘I_SalesOrderTemplate’ }
} }
@EndUserText.label: ‘Auto assigned mapping role for
I_SalesOrderStdVH’
@MappingRole: true
define role I_SalesOrderStdVH {
  grant select on I_SalesOrderStdVH
  WHERE ( SalesOrderType ) =
  ASPECT PFCG_AUTH (v_vbak_aat,
```

auart,
actvt = ‘03’ )

```
  OR ( SalesOrderType ) =
  ASPECT PFCG_AUTH (v_vbak_aat,
```

auart,
actvt = ‘F4’);

An example use case can include a “Remote API” use case. The example remote API can provide a stable interface for consumers that do not have system internal lifecycle. In this context, a complete decoupling of system-internally used views can be required. A remote API view may only associate other remote API views. The scope of an individual remote API service can be defined by a single object without integrating related objects. For example, the service for the object Sales Order can include three entities Sales Order Header, Sales Order Item and Sales Order Schedule Line. The associated Product does not become part of this service. Instead there can be a dedicated service defined for the object product, which itself can include the entities Product and Product Text. This isolation enables a suitable localized versioning, if incompatible changes cannot be avoided.

In some implementations, when generating a remote API runtime model by the CDSVT infrastructure, only those annotations which are admissible to be used in a remote API service are transferred to the generated model. In addition, target views of relevant associations are replaced by suitable remote API runtime views (e.g. I_SalesOrderItemTemplate is replaced by A_SalesOrderItem). The following table 9 includes an example generated remote API runtime CDS view.

TABLE 9
@ViewTemplating: { master: { object: { type:#STOB, name:‘I_SalesOrderTemplate’ }
},

```
  useCase: #REMOTE_API,
  dependency: [ { object: { type: #STOB, name: ‘A_SalesOrderItem’ },
```

replacedObject: { type: #STOB,
name: ‘I_SalesOrderItemTemplate’ } }],

synchronization: { check: { priority: #HIGH } }
}

@AbapCatalog.sqlViewName: ‘ASO’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@ObjectModel: { compositionRoot: true,

representativeKey: ‘SalesOrder’ }

```
@VDM.viewType: #COMPOSITE
@Metadata.ignorePropagatedAnnotations: true
define view A_SalesOrder
  as select from vbak
  association [0..*] to A_SalesOrderItem as _Item on $projection.SalesOrder =
_Item.SalesOrder
{
  key cast ( vbak.vbeln as vdm_sales_order preserving type ) as SalesOrder,
```

| @Consumption.hidden: true | |
|---|---|
| vbak.auart | as SalesOrderType, |

| | |
|---|---|
| vbak.kunnr | as SoldToParty, |

@ObjectModel.association.type: [#TO_COMPOSITION_CHILD]
_Item

} where vbak.vbtyp = ‘C’

In some implementations, the runtime DCL model can represent a copy of the template DCL model. This holds true, for example, for remote API runtime DCL models.

Another example use case can include a UI service use case. In some implementations, a purpose of non-remote API OData services is to drive UI applications. If these UI applications are based on Fiori Elements, the metadata of the service already contains information which is relevant for rendering and running the respective UI application. In the example, the CDS model can be an additional source of this information. Accordingly, the generated runtime model can support this use case by exposing the corresponding information. It therefore can include, e.g., all UI annotations of the template model. Furthermore, it can provide value helps for foreign key associations and can automatically denormalize language and time-dependent texts. Transactional processing related information of the template model can be mapped onto a suitable delegation approach. Annotations defining the aggregation behavior or the temporal nature of the entity can be transferred from the template model to the runtime model if the template view is defined as an aggregation respectively temporal model. As a result, in the exemplary case the annotation @DefaultAggregation: #SUM of the template model is skipped/not transferred to the runtime model. For searchable views the scope of the search relevant fields (@Search.defaultSearchElement: true) is enhanced by the denormalized fields which are annotated accordingly. The following table 10 includes an example generated UI service runtime CDS view.

TABLE 10
@ViewTemplating: { master: { object: { type:#STOB, name:‘I_SalesOrderTemplate’ }
},

useCase: #UI_SERVICE,
dependency: [ { object: { type: #STOB, name: ‘C_SalesOrderItem’ },

replacedObject: { type: #STOB,

name: ‘I_SalesOrderItemTemplate’ } },

{ object: { type: #STOB, name: ‘I_SalesOrderTypeStdVH’ },
replacedObject: { type: #STOB,

name: ‘I_SalesOrderTypeTemplate’ } },

{ object: { type: #STOB, name: ‘I_CustomerStdVH’ },
replacedObject: { type: #STOB,

name: ‘I_CustomerTemplate’ } } ],

synchronization: { check: { priority: #HIGH } }

}

@AbapCatalog.sqlViewName: ‘CSO’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@ObjectModel: { compositionRoot: true,

representativeKey: ‘SalesOrder’ }

```
@VDM.viewType: #CONSUMPTION
@Metadata.ignorePropagatedAnnotations: true
@Search.searchable: true
define view C_SalesOrder
as select from vbak
left outer to one join tvakt
  on tvakt.auart = vbak.auart
  and tvakt.spras = $session.system_language
left outer to one join kna1
  on kna1.kunnr = vbak.kunnr
  association [0..*] to C_SalesOrderItem as _Item on $projection.SalesOrder =
_Item.SalesOrder
{
key cast ( vbak.vbeln as vdm_sales_order preserving type ) as SalesOrder,
```

@Consumption.valueHelpDefinition: [
{ entity: { name: ‘I_SalesOrderTypeStdVH’,

element: ‘SalesOrderType’ }

| }] | |
|---|---|
| @ObjectModel.text.element: [‘SalesDocumentTypeName’] | |
| vbak.auart | as SalesOrderType, |

@Semantics.text: true
@Search.defaultSearchElement: true
cast ( tvakt.bezei as salesdocumenttypename preserving type ) as

SalesDocumentTypeName,

@Consumption.valueHelpDefinition: [
{ entity: { name: ‘I_CustomerStdVH’,

element: ‘Customer’ }

| }] | |
|---|---|
| @ObjectModel.text.element: [‘SalesDocumentTypeName’] | |
| @Search.defaultSearchElement: true | |
| vbak.kunnr | as SoldToParty, |

@Semantics.text:true
cast(substring(rtrim(replace(concat(kna1.name1,concat(‘

&@’,kna1.name2)),‘&@’,‘ ’),

| | |
|---|---|
| ‘ ’),1,80) as md_customer_name) | as CustomerName, |

| @Semantics.amount.currencyCode: ‘TransactionCurrency’ | |
|---|---|
| vbak.netwr | as TotalNetAmount, |
| @Semantics.currencyCode: true | |
| vbak.waerk | as TransactionCurrency, |

@ObjectModel.association.type: [#TO_COMPOSITION_CHILD]
_Item

} where vbak.vbtyp = ‘C’

If the inclusion of value helps and the denormalization of texts is not to be applied, this option can be deselected by the developer in the generation wizard and results for example by the additional annotations: @ViewTemplating.option: [{name: #ADD_VALUE_HELP_FOR_FOREIGN_KEY, excluding: true}]; respectively @ViewTemplating.option: [{name: #DENORMALIZE_FOREIGN_KEY_TEXT, excluding: true}].

The DCL can be defined according to its template definition. The following table 11 includes an example generated UI service runtime DCL.

TABLE 11

```
@ViewTemplating: { master: { object:{ type:#DCLS,
name:‘I_SalesOrderTemplate’ } }
}
@EndUserText.label: ‘Auto assigned mapping role for
C_SalesOrder’
@MappingRole: true
define role C_SalesOrder {
  grant select on C_SalesOrder
  WHERE ( SalesOrderType ) =
  ASPECT PFCG_AUTH (v_vbak_aat,
```

auart,
actvt = ‘03’ );

}

Another example use case includes an analytical info source use case. In the example, an analytical information source serves as a data provider of an analytical query. It can be defined as a CUBE, DIMENSION, FACT, TEXT or HIERARCHY view. Only fields (i.e. properly defined measures and characteristics), associations (foreign key, text and hierarchy associations) and annotations (mainly from the domains @Analytics, @ObjectModel, @Semantics, @Aggregation) that are interpreted by the analytical engine are transferred from the template model to the generated runtime model. Additionally, the annotation @Analytics.internalName: #LOCAL is set, specifying that the names of the internal representation of the CDS models inside the analytical engine are governed by the local element names and not derived from associated info providers. The following table 12 includes an example generated analytical info source runtime CDS view.

TABLE 12
@ViewTemplating: { master: { object: { type:#STOB, name:‘I_SalesOrderTemplate’ }
},

```
  useCase: #ANALYTICAL_INFO_SOURCE,
  dependency: [ { object: { type: #STOB, name:
```

‘I_SalesOrderTypeDimension’ },

replacedObject: { type: #STOB,

name: ‘I_SalesOrderTypeTemplate’ } },

{ object: { type: #STOB, name: ‘I_CustomerDimension’ },
replacedObject: { type: #STOB,

name: ‘I_CustomerTemplate’ } } ],

synchronization: { check: { priority: #HIGH } }
}

@AbapCatalog.sqlViewName: ‘ISODIM’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@Analytics.dataCategory: #DIMENSION
@ObjectModel.representativeKey: ‘SalesOrder’
@VDM.viewType: #COMPOSITE
@Metadata.ignorePropagatedAnnotations: true
@Analytics.internalName: #LOCAL
define view I_SalesOrderDimension
as select from vbak
association [0..1] to I_SalesOrderTypeDimension as _SalesOrderType

on $projection.SalesOrderType = _SalesOrderType.SalesOrderType

association [0..1] to I_CustomerDimension as _SoldToParty

on $projection.SoldToParty = _SoldToParty.Customer

{
key cast( vbak.vbeln as vdm_sales_order preserving type ) as SalesOrder,

| @ObjectModel.foreignKey.association: ‘_SalesOrderType’ | |
|---|---|
| vbak.auart | as SalesOrderType, |
| @ObjectModel.foreignKey.association: ‘_SoldToParty’ | |
| vbak.kunnr | as SoldToParty, |
| @DefaultAggregation: #SUM | |
| @Semantics.amount.currencyCode: ‘TransactionCurrency’ | |
| vbak.netwr | as TotalNetAmount, |
| @Semantics.currencyCode: true | |
| vbak.waerk | as TransactionCurrency, |

```
  _SalesOrderType,
  _SoldToParty
```

}

The runtime DCL can be defined according to its template definition. The following table 13 includes an example generated analytical info source runtime DCL.

TABLE 13

```
@ViewTemplating: { master: { object: { type:#DCLS,
name:‘I_SalesOrderTemplate’ }
} }
@EndUserText.label: ‘Auto assigned mapping role for
I_SalesOrderDimension’
@MappingRole: true
define role I_SalesOrderDimension {
  grant select on I_SalesOrderDimension
  WHERE ( SalesOrderType ) =
  ASPECT PFCG_AUTH (v_vbak_aat,
```

auart,
actvt = ‘03’ );

}

Another example use case includes an analytical query use case. In the example, an analytical query view provides access to and is based on an analytical data source (CUBE or DIMENSION view). It does neither define nor expose associations. By default, the runtime artefact is aggregated to the uppermost level (e.g., only the key figures are displayed without their dependencies to characteristics, see usage of the annotation @AnalyticsDetails.query.axis: #ROWS). The runtime model of the analytical view is assigned the annotation @Analytics.query:true. Parameters of the data source are transferred to the runtime model. On element level only annotations of the domains @AnalyticsDetails and @Consumption are added. The following table 14 includes an example generated analytical query runtime CDS view.

TABLE 14
@ViewTemplating: { master: { object:) type:#STOB, name:‘I_SalesOrderTemplate’} },

useCase: #ANALYTICAL_QUERY,
dependency: [ { object: { type: #STOB, name: ‘I_SalesOrderDimension’ },

replacedObject: { type: #STOB,
name: ‘I_SalesOrderTemplate’ } },

{ object: { type: #STOB, name: ‘I_CustomerDimension’ } } ],
synchronization: { check: { priority: #HIGH } }

}

@AbapCatalog.sqlViewName: ‘CSOQRY’
@AbapCatalog.compiler.compareFilter: true
@AccessControl.authorizationCheck: #PRIVILEGED_ONLY
@EndUserText.label: ‘Sales Order Query’
@ClientHandlmg.algorithm: #SESSION_VARIABLE
@Analytics.query: true
@VDM.viewType: #CONSUMPTION
@Metadata.ignorePropagatedAnnotations: true
define view C_SalesOrderQuery
as select from I_SalesOrderDimension
{
key SalesOrder,

SalesOrderType,
SoldToParty,
@AnalyticsDetails.query.axis: #ROWS
TotalNetAmount,
TransactionCurrency

}

The view itself can be protected by a special DCL, which blocks unprivileged access (@AccessControl.authorizationCheck:#PRIVILEGED_ONLY). This can be achieved, for example, by a DCL which rule is never true as no runtime SQL access to the query view shall be allowed. The following table 15 includes an example generated analytical query runtime DCL.

TABLE 15

```
@ViewTemplating: { master: { object: { type:#DCLS,
name:‘I_SalesOrderTemplate’ }}
}
@EndUserText.label: ‘Auto assigned mapping role for
C_SalesOrderQuery’
@MappingRole: true
define role C_SalesOrderQuery {
  grant select on C_SalesOrderQuery
WHERE ( SalesOrder is null )
  AND ( SalesOrder is not null );
}
```

Another example use case includes a form template use case. In the example, a form template defines the data structure for print forms. It is defined as a special consumption view that projects elements. Most of the CDS annotations are not relevant and are excluded from the generated runtime model. From a structural perspective considering the projected fields and associations the view model looks like an UI service model. The following table 16 includes an example generated form template runtime CDS view.

TABLE 16
@ViewTemplating: { master: { object: { type:#STOB, name:‘I_SalesOrderTemplate’ }
},

useCase: #FORM_TEMPLATE,
dependency: [ { object: { type: #STOB, name: ‘C_SalesOrderItemFDP’ },

replacedObject: { type: #STOB,
name: ‘I_SalesOrderItemTemplate’ } },

{ object: { type: #STOB, name: ‘I_SalesOrderTypeFDP’ },

replacedObject: { type: #STOB,

```
name: ‘I_SalesOrderTypeTemplate’ } },
  { object: { type: #STOB, name: ‘I_CustomerFDP’ },
replacedObject: { type: #STOB,
  name: ‘I_CustomerTemplate’ } } ],
```

synchronization: { check: { priority: #HIGH } }

}

@AbapCatalog.sqlViewName: ‘CSOFDP’
@AbapCatalog.compiler.compareFilter: true
@AccessControl.authorizationCheck: #CHECK
@EndUserText.label: ‘Sales Order’
@ClientHandlmg.algorithm: #SESSION_VARIABLE
@ObjectModel: { compositionRoot: true,

representativeKey: ‘SalesOrder’ }

```
@VDM.viewType: #CONSUMPTION
@Metadata.ignorePropagatedAnnotations: true
@Search.searchable: true
define view C_SalesOrderFDP
as select from vbak
left outer to one join tvakt
on tvakt.auart = vbak.auart
and tvakt.spras = $session.system_language
left outer to one join kna1
  on kna1.kunnr = vbak.kunnr
  association [0..*] to C_SalesOrderItemFDP as _Item
```

on $projection.SalesOrder = _Item.SalesOrder

{
key cast ( vbak.vbeln as vdm_sales_order preserving type ) as SalesOrder,

| @ObjectModel.text.element: [‘SalesDocumentTypeName’] | |
|---|---|
| vbak.auart | as SalesOrderType, |

```
  @Semantics.text: true
  cast ( tvakt.bezei as salesdocumenttypename preserving type ) as
```

SalesDocumentTypeName,

| @ObjectModel.text.element: [‘SalesDocumentTypeName’] | |
|---|---|
| vbak.kunnr | as SoldToParty, |

```
  @Semantics.text:true
  cast(substring(rtrim(replace(concat(kna1.name1,concat(‘
```

&@’,kna1.name2)),‘&@’,‘ ’

| | |
|---|---|
| ‘ ’),1,80) as md_customer_name) | as CustomerName, |

| @Semantics.amount.currencyCode: ‘Trans actionCurrency’ | |
|---|---|
| vbak.netwr | as TotalNetAmount, |
| @Semantics.currencyCode: true | |
| vbak.waerk | as TransactionCurrency, |

```
  @ObjectModel.association.type: [#TO_COMPOSITION_CHILD]
  _Item
```

} where vbak.vbtyp = ‘C’
WHERE ( SalesOrder is null )
AND ( SalesOrder is not null );
}

In the example, no SQL optimization is required since the view itself does not serve as a data basis. It gets an access protection which always blocks unexpected data access via a corresponding DCL similar to the query use case. The following table 17 includes an example generated form template runtime DCL.

TABLE 17

@ViewTemplating: { master: { object: { type:#DCLS,
name:‘I_SalesOrderTemplate’ }
} }
@EndUserText.label: ‘Auto assigned mapping role for
C_SalesOrderFDP’
@MappingRole: true
define role C_SalesOrderFDP {

grant select on C_SalesOrderFDP

Another example use case includes a SQL data source use case. In the example, if a view is defined as a plain SQL data source, only elementary element annotations will be included like @Semantics.amount.currencyCode. The view may serve as a reusable building block within a more comprehensive view hierarchy or already define the data source for the consumers. By default, no association is exposed. In contrast to the form template the SQL optimization is required and a suitable DCL is generated. The following table 18 includes an example generated SQL data source runtime CDS view.

TABLE 18
@ViewTemplating: { master: { object: { type:#STOB, name:‘I_SalesOrderTemplate’ }
},

```
  useCase: #SQL_DATA_SOURCE,
  synchronization: { check: { priority: #HIGH } }
}
```

@AbapCatalog.sqlViewName: ‘ISODS’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@VDM.viewType: #COMPOSITE
@Metadata.ignorePropagatedAnnotations: true
define view I_SalesOrderDataSource
as select from vbak
{
key cast ( vbak.vbeln as vdm_sales_order preserving type ) as SalesOrder,

| | |
|---|---|
| vbak.auart | as SalesOrderType, |

| vbak.kunnr | as SoldToParty, |
|---|---|
| @Semantics.amount.currencyCode: ‘TransactionCurrency’ | |
| vbak.netwr | as TotalNetAmount, |
| @Semantics.currencyCode: true | |
| vbak.waerk | as TransactionCurrency |

} where vbak.vbtyp = ‘C’

In the example, the DCL can be defined according to its template definition. The following table 19 includes an example generated SQL data source runtime DCL.

TABLE 19

```
@ViewTemplating: { master: { object: { type:#DCLS,
name:‘I_SalesOrderTemplate’} }
}
@EndUserText.label: ‘Auto assigned mapping role for
I_SalesOrderDataSource’
@MappingRole: true
define role I_SalesOrderDataSource {
  grant select on I_SalesOrderDataSource
  WHERE ( SalesOrderType ) =
  ASPECT PFCG_AUTH (v_vbak_aat,
```

auart,
actvt = ‘03’ );

}

Another example use case includes an enterprise search use case. In the example, the enterprise search model is a denormalized model which can enable the user to find object instances by leveraging fuzzy search capabilities. Operations which prevent the successful application of the search features can be removed from the enterprise search models used at runtime.

In the example, the view includes the search enabled fields of first level foreign key targets and their non-localized texts, which result in changing the key of the runtime model. The semantic key, which identifies object instances within the result set, is captured by the annotation @ObjectModel.semanticKey. Associations are removed from the generated view. The following table 20 includes an example generated enterprise search runtime CDS view.

TABLE 20
@ViewTemplating: { master: { object: { type:#STOB, name:‘I_SalesOrderTemplate’ }
},

useCase: #ENTERPRISE_SEARCH,
synchronization: { check: { priority: #HIGH } }

}

@AbapCatalog.sqlViewName: ‘CSOES’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@ObjectModel.semanticKey: [‘SalesOrder’]
@VDM.viewType: #CONSUMPTION
@Metadata.ignorePropagatedAnnotations: true
@Search.searchable: true
@EnterpriseSearch.enabled: true
define view C_SalesOrderES
as select from vbak
left outer to many join tvakt
on tvakt.auart = vbak.auart
{
key cast ( vbak.vbeln as vdm_sales_order preserving type ) as SalesOrder,

| key tvakt.spras | | as SalesOrderTypeLanguage, |
|---|---|---|
| | @ObjectModel.text.element: [‘SalesDocumentTypeName’] | |
| | vbak.auart | as SalesOrderType, |

@Semantics.text: true
@Search.defaultSearchElement: true
cast ( tvakt.bezei as salesdocumenttypename preserving type ) as

SalesDocumentTypeName,

| @Search.defaultSearchElement: true | |
|---|---|
| vbak.kunnr | as SoldToParty |

} where vb

In the example, the DCL is defined according to its template definition. The following table 21 includes an example generated enterprise search runtime DCL.

TABLE 21

```
@ViewTemplating: { master: { object: { type:#DCLS,
name:‘I_SalesOrderTemplate’ }
} }
@EndUserText.label: ‘Auto assigned mapping role for
C_SalesOrderES’
@MappingRole: true
define role C_SalesOrderES {
  grant select on C_SalesOrderES
  WHERE ( SalesOrderType ) =
  ASPECT PFCG_AUTH (v_vbak_aat,
```

auart,
actvt = ‘03’ );

}

In some example implementations, using additional information, @ ViewTemplating.option:[{name: #IGNORE_VALUE_CHANGE_BY_FUNCTION}] additional source database fields of calculated fields may be included in the generated runtime model by removing problematic statements conflicting with the technical restrictions of the search functionality, respectively, which can represent an unnecessary overhead for the runtime execution. For example, instead of using a field definition like key cast(substring(dd071.domvalue_1, 1, 1) as vabme) as VarblPurOrdUnitActvtnStatus, the following field can be added augmented with the label text annotations derived from the removed cast data element vabme: @EndUserText.label: ‘Variable Purchase Order Unit’ key dd071.domvalue_1 as VarblPurOrdUnitActvtnStatus.

Another example use case includes a decoupled model use case. In the example, a decoupled model may be used if the design time template model already matches the use case from a functional perspective or/and if it shall be used as the basis for defining a reuse runtime model, which other runtime models shall be based upon. The functionality (fields, associations, annotations) of the template model is transferred. Only its dependencies are changed. The following table 22 includes an example generated runtime CDS view of a decoupled model.

TABLE 22
@ViewTemplating: { master: { object: { type:#STOB, name:‘I_SalesOrderTemplate’ }
},

useCase: #FORM_TEMPLATE,
dependency: [ { object: { type: #STOB, name: ‘I_SalesDocumentReuse’ },

replacedObject: { type: #STOB,
name: ‘I_SalesDocumentTemplate’ } },

{ object: { type: #STOB, name: ‘I_SalesOrderItemReuse’ },

replacedObject: { type: #STOB,
name: ‘I_SalesOrderItemTemplate’ } },

{ object: { type: #STOB, name: ‘I_SalesOrderTypeReuse’ },

replacedObject: { type: #STOB,
name: ‘I_SalesOrderTypeTemplate’ } },

{ object: { type: #STOB, name: ‘I_CustomerReuse’ },

replacedObject: { type: #STOB,
name: ‘I_CustomerTemplate’ } } ],

synchronization: { check: { priority: #HIGH } }

}

@AbapCatalog.sqlViewName: ‘ISOREUSE’
@AbapCatalog.compiler.compareFilter: true
@AccessControl.authorizationCheck: #CHECK
@EndUserText.label: ‘Sales Order’
@ClientHandling.algorithm: #SESSION_VARIABLE
@Analytics.dataCategory: #DIMENSION
@ObjectModel: { compositionRoot: true,

representativeKey: ‘SalesOrder’ }

```
@VDM.viewType: #COMPOSITE
@Search.searchable: true
define view I_SalesOrderReuse
  as select from I_SalesDocumentReuse
  association [0..1] to I_SalesOrderTypeReuse as _SalesOrderType
```

on $projection.SalesOrderType = _SalesOrderType.SalesOrderType

```
association [0..*] to I_SalesOrderItemReuse as _Item
  on $projection.SalesOrder = _Item.SalesOrder
  association [0..1] to I_CustomerReuse as _SoldToParty
```

on $projection.SoldToParty = _SoldToParty.Customer

{
key cast( SalesDocument as vdm_sales_order preserving type ) as SalesOrder,

```
  @ObjectModel.foreignKey.association: ‘_SalesOrderType’
  SalesDocumentType as SalesOrderType,
  @Search.defaultSearchElement: true
  @ObjectModel.foreignKey.association: ‘_SoldToParty’
  SoldToParty,
  @DefaultAggregation: #SUM
  @Semantics.amount.currencyCode: ‘TransactionCurrency’
  TotalNetAmount,
  @Semantics.currencyCode: true
  TransactionCurrency,
  @ObjectModel.association.type: [#TO_COMPOSITION_CHILD]
  _Item,
  _SalesOrderType,
  _SoldToParty
```

}

In the example, the DCL is defined according to its template definition. The following table 23 includes an example generated runtime DCL of a decoupled model.

TABLE 23

```
@ViewTemplating: { master: { object:{type:#DCLS,
name:‘I_SalesOrderTemplate’}} }
@EndUserText.label: ‘Auto assigned mapping role for
I_SalesOrderReuse’
@MappingRole: true
define role I_SalesOrderReuse {
  grant select on I_SalesOrderReuse
  WHERE ( SalesOrderType ) =
  ASPECT PFCG_AUTH (v_vbak_aat,
```

auart,
actvt = ‘03’ );

}

The use case examples given above illustrate that a single template definition can be used for generating multiple runtime models that are tailored for specific use cases. These generated models can reflect the latest state of the respective guidelines and recommendations. Such an approach can avoid error-prone and time-consuming activity for a developer to define specific models manually, which also may not guarantee consistency between models. In contrast, CDSVT generation logic utilizes the latest systems. For example, in the generated UI service runtime CDS view, the text denormalization utilizes the session variable system_language for retrieving the proper language-dependent text. If the underlying SADL infrastructure supports a different text modeling, e.g., for handling language vectors and fallback languages via dedicated CDS functions, the CDSVT can offer a generic replacement of the corresponding current statement in its generated runtime view models with the new CDS/SADL feature.

The CDSVT can improve lifecycle handling. For example, assume that the template model I_SalesOrderTemplate was used to generate two models including a value help model and a remote API view as described above. After the initial generation, the projection list of the template model I_SalesOrderTemplate is enriched by the following additional field: SalesDocumentProcessingType as SalesOrderProcessingType. In this case, the checker component of the CDSVT infrastructure can provide an ATC check option, which can raise an issue of priority high (@ViewTemplating.synchronization.check.priority: #HIGH) for the generated runtime model A_SalesOrder indicating that there is a new field introduced in the underlying template model that is not reflected in the remote API runtime model. The remote API view A_SalesOrder includes this additional field, if it is newly generated. In contrast, for the generated value help view no finding will be reported since the field is not utilized during its generation (e.g., it is not relevant for the standard value help functionality). The developer is free to change the priority of the check, e.g., from #HIGH to #LOW or remove the check option if they do not want to be informed about any changes of the design time model.

Based on this finding, the developer can decide to include or exclude the new field into the already generated runtime model A_SalesOrder by using the CDSVT synchronizer. If they want to include the field, the CDSVT synchronization component can trigger the adaption of the view model A_SalesOrder and include the field as: vbak.vbklt as SalesOrderProcessingType.

If the developer decides that the remote API shall not receive this field and wants to remove the ATC finding, they can, e.g., manually add the following annotation to the generated view A_SalesOrder or use the CDSVT synchronization component to do this: @ ViewTemplating.synchronization: {element:[{name:‘SalesOrderProcessingType’, excluding:true}]}; define view I_SalesOrderStdVH. This annotation excludes the field SalesOrderProcessingType from any synchronization and related checks.

In addition to the changes of the template model, the CDSVT can also allow manual refinements of the generated artefacts. For example, the developer can decide to enable additional search capabilities for the generated value help runtime view I_SalesOrderStdVH by adding the related annotation @Search.defaultSearchElement: true to the field SalesOrder. The following table 24 includes an example runtime model with enhanced search capabilities.

TABLE 24
define view I_SalesOrderStdVH

as select from vbak

{
@Search.defaultSearchElement: true

```
  key cast ( vbak.vbeln as vdm_sales_order preserving type ) as
  SalesOrder,
```

This manual change can be recognized by the CDSVT checker and a corresponding finding can be issued, telling the developer that these annotations are not originating from the template model I_SalesOrderTemplate. The developer can exclude this annotation from the check, e.g., by adding the following annotation to the generated runtime model either manually or by the CDSVT-tool. @ ViewTemplating.synchronization: {annotation:[{name: ‘Search’, excluding:true}]}) define view I_SalesOrderStdVH. This annotation indicates that any annotation starting with the prefix “Search” at any level (e.g., scope is unrestricted) is excluded from the synchronization process.

If the developer only wants to exclude the single newly added search annotation from the check for the specific field SalesOrder itself, e.g. the following table 25 includes annotation that can be an added to the runtime model.

TABLE 25
define view I_SalesOrderStdVH
as select from vbak
{
@ViewTemplating.synchronization:{annotation:[{name:‘Search.defaultSearchElement’,

excluding:true}]}

@Search.defaultSearchElement: true

key cast ( vbak.vbeln as vdm_sales_order preserving type ) as SalesOrder.

If the developer, however, decides to transfer this annotation into the underlying template model I_SalesOrderTemplate, they can manually perform this step or by using the CDSVT synchronizer, which can update the template model with the newly added annotation accordingly.

In some implementations, the CDSVT logic first evaluates the use case (@ViewTemplating.useCase), which may be overruled by the refinements on option level (@ViewTemplating.option), which themselves may be overruled by refinements on more specific level starting from entity to the entity components (fields, associations and parameters) and ending at individual functions and annotations (@ViewTemplating.synchronization). Therein the annotations inside @ViewTemplating support both whitelisting (e.g., excluding=false (default if not explicitly specified)) and blacklisting (e.g., excluding=true) of settings reducing the maintenance efforts for the related annotations.

In some implementations, CDSVT can enable efficient development and maintenance of CDS views, which can be optimized for database processing and tailored for a given use case by separation of the semantic rich, easy to define, and to consume design time template data model from its runtime relevant implementation. Though both models are decoupled, the template model is not isolated. Instead it can be the basis for deriving the runtime model and can establish a close relationship to the run time model via the CDSVT check and synchronization infrastructure.

In some implementations, within the tool-supported conversion from the design time to the runtime model there can be included an automated optimization, which leverages available metadata and context information enriched by information defined by the developer in order to reduce the static SQL view complexity (e.g., compared to the complexity of the design time template model) and to adjust the runtime models for serving dedicated use cases (e.g., by removing or adding fields and annotations).

In some implementations, the initial conversion checks and tool-supported adjustment options allow the developer to decide on (bi-directionally) transferring model changes and thus to keep both the design time and runtime models synchronized.

In some implementations, as a result of the SQL pre-optimization, the database optimizer can define an efficient execution plan, which can reduce processing load on the data base system and increase the overall performance. Due to lower complexity, the execution plan becomes more predictable avoiding unexpected issues at customer side. Since the pre-optimization option can be available for all databases the any database principle is supported.

In some implementations, the CDSVT allows for isolation of the runtime view models from one another by defining suitable reuse-runtime models. Thus, the reuse of view models for efficiently defining complex logic on SQL level by leveraging caches and applying automated tests can be achieved. However, due to the potential isolation at any level of the view hierarchy, the activation can be localized and activation times of views may significantly be reduced. Furthermore, unwanted negative side effects of changes of reuse views can effectively be avoided without increasing maintenance efforts for the developers. The decoupling option can also be used for versioning the runtime view models. This can be required if stability requirements for released views contradict the envisioned changes of the views. Such an approach can alleviate the need for the developer to duplicate entire view stacks with increased maintenance efforts in order to comply with such stability requirements.

In some implementations, because the CDS view template is formally represented by a CDS view model without generated SQL view, some existing CDS infrastructure can be used for definition with limited modification. The optimization of the template model by a pre-processing step can be implemented isolated from the existing infrastructure as an additional separated tool.

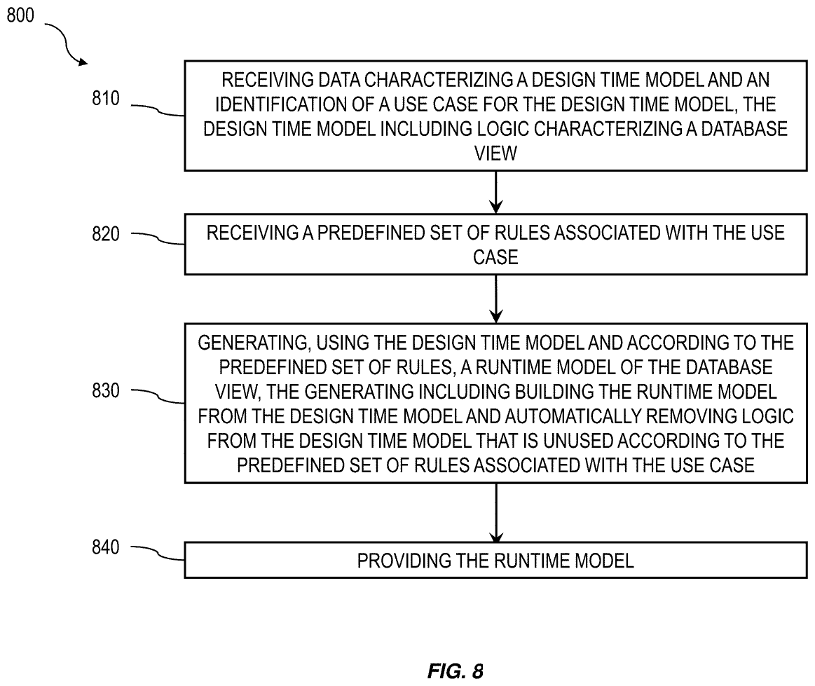

FIG. 8 is a process flow diagram illustrating an example process 800 of generating a runtime model. At 810, a design time model and an identification of a use case for the design time model is received. The design time model includes logic characterizing a database view. For example, the logic can include ABAP and/or SQL expressions that when implemented by the database can create the database view. For example, the design time model can includes logic such as a join operation. The use case can include an intended application that will consume database query results utilizing the runtime model of the database view.

At 820, a predefined set of rules associated with the use case is received. The predefined rules can include rules characterizing which portions of the logic and/or metadata of the design time model is used for the identified use case. In some implementations, the set of rules includes annotation of a core data services entity.

At 830, a runtime model of the database view can be generated. The generating can be performed using the design time model and according to the predefined set of rules. The generating can include building the runtime model from the design time model and automatically removing logic from the design time model that is unused according to the predefined set of rules associated with the use case. All design time model metadata can be evaluated using the predefined set of rules.

In some implementations, the design time model can include logic such as a join operation and the generating can include identifying that the first join of the design time model is unused for the identified use case. The first join can be removed from the runtime model. In some implementations, logic can be added to the runtime model. For example, an annotation, an element, a field, and/or an access protection can be added to the runtime model according to the predefined set of rules.

At 840, the runtime model can be provided. For example, the runtime model can be used to create a view model that can be consumed by an application, which can expose the data to user interface clients.

In some implementations, differences between the design time model and the run time model can be detected. The detected differences can be provided, via a graphical user interface, to a developer.

In some implementations, an update to the design time model can be received. The design time model can be updated and the run time model can be synchronized with the updated design time model.

Although a few variations have been described in detail above, other modifications or additions are possible. For example, instead of capturing the mapping from the designtime to the runtime model via CDS annotations of the domain @ViewTemplating, native CDS language elements and artefacts may be used. Other predefined use cases may be supported as well such as Data Extraction. In addition, the CDSVT infrastructure may be implemented on the database system and the like. For example, the CDSVT infrastructure can be provided on HANA allowing to support HANA CDS models as well. In some implementations, the current subject matter can be used for deriving database tables, table functions, SQL scripts, ABAP, and the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a design time model and an identification of a use case for the design time model, the design time model including logic characterizing a database view;
receiving a predefined set of rules associated with the use case;
generating, using the design time model and according to the predefined set of rules, a runtime model of the database view, the generating including building the runtime model from the design time model and automatically removing logic from the design time model, the removed logic being unused and removed according to the predefined set of rules associated with the use case; and
providing the runtime model.

2. The method of claim 1, wherein the generating includes evaluating design time model metadata using the predefined set of rules.

3. The method of claim 1, wherein the design time model includes logic including a first join operation, the generating including identifying that the first join of the design time model is unused for the identified use case and removing the first join from the runtime model.

4. The method of claim 1, wherein the generating includes adding, to the runtime model and according to the predefined set of rules, an annotation, an element, a field, and/or an access protection.

5. The method of claim 1, wherein the runtime model includes structured query language expressions.

6. The method of claim 1, wherein the set of rules includes annotation of a core data services entity.

7. The method of claim 1, wherein the use case includes an intended application configured to consume database query results utilizing the runtime model of the database view.

8. The method of claim 1, wherein the receiving is performed using a user interface application.

9. The method of claim 1, further comprising:
detecting differences between the design time model and the run time model; and
providing, via a graphical user interface, the detected differences to a user interface associated with a developer.

10. The method of claim 1, further comprising:
receiving an update to the design time model;
updating the design time model; and
synchronizing the run time model with the updated design time model;
wherein at least one of the receiving, the generating, and the providing are performed by at least one data processor forming part of at least one computing system.

11. A system comprising:
at least one data processor;
memory storing instructions which, when executed by the at least one data processor, causes the at least one data processor to perform operations comprising:
receiving data characterizing a design time model and an identification of a use case for the design time model, the design time model including logic characterizing a database view;
receiving a predefined set of rules associated with the use case;
generating, using the design time model and according to the predefined set of rules, a runtime model of the database view, the generating including building the runtime model from the design time model and automatically removing logic from the design time model, the removed logic being unused and removed according to the predefined set of rules associated with the use case; and
providing the runtime model.

12. The system of claim 11, wherein the generating includes evaluating design time model metadata using the predefined set of rules.

13. The system of claim 11, wherein the design time model includes logic including a first join operation, the generating including identifying that the first join of the design time model is unused for the identified use case and removing the first join from the runtime model.

14. The system of claim 11, wherein the generating includes adding, to the runtime model and according to the predefined set of rules, an annotation, an element, a field, and/or an access protection.

15. The system of claim 11, wherein the runtime model includes structured query language expressions.

16. The system of claim 11, wherein the set of rules includes annotation of a core data services entity.

17. The system of claim 11, wherein the use case includes an intended application configured to consume database query results utilizing the runtime model of the database view.

18. The system of claim 11, wherein the receiving is performed using a user interface application.

19. The system of claim 11, the operations further comprising:
detecting differences between the design time model and the run time model; and
providing, via a graphical user interface, the detected differences to a user interface associated with a developer.

20. A non-transitory computer readable medium storing instructions, which when executed by at least one data processor of at least one computing system, implement operations comprising:
receiving data characterizing a design time model and an identification of a use case for the design time model, the design time model including logic characterizing a database view;
receiving a predefined set of rules associated with the use case;
generating, using the design time model and according to the predefined set of rules, a runtime model of the database view, the generating including building the runtime model from the design time model and automatically removing logic from the design time model, the removed logic being unused and removed according to the predefined set of rules associated with the use case; and
providing the runtime model.
